(19) United States
(12) Patent Application Publication
(10) Pub. No.: US 2014/0166167 A1
(43) Pub. Date: Jun. 19, 2014

(54) BICYCLE TIRE COVER

(71) Applicant: CROPS CO., LTD., TOKYO (JP)

(72) Inventor: KEIJI TAIGA, TOKYO (JP)

(73) Assignee: CROPS CO., LTD., TOKYO (JP)

(21) Appl. No.: 13/713,167

(22) Filed: Dec. 13, 2012

(51) Int. Cl. B62J 23/00

(52) U.S. Cl. CPC B62J 23/00
USPC 150/166

(57) ABSTRACT

A bicycle tire cover includes an elongate body having two edges which are folded downward to form the body as a U-shaped cover. A connection portion includes a first connection member on the first end of the body, and a second connection member on the second end of the body. Two resilient portions are connected to each of the two edges respectively. The body is mounted to a tire, and the first and second connection portions connected to each other to secure the tire cover to the tire. The tire cover is easily mounted to the tire while the tire does not need to be removed from the bicycle frame.

### FIELD OF THE INVENTION

The present invention relates to a bicycle tire cover, and more particularly, to a bicycle tire cover which covers the tire without removing the tire from the bicycle frame.

### BACKGROUND OF THE INVENTION

Bicycles are one of the popular exercises today and many cyclists carry their bicycles to places with different terrains to experience specific cycling performances. The bicycles can be carried by bicycle racks which are connected to the cars so as to quickly reach the destinations away from homes.

The derailleur system and the quick releases of the bicycles are spread with grease so that when the bicycles are carried by the bicycle racks or even are positioned in the larger cars, the grease is easily attached to the users' clothes or the seats. The grease is difficult to remove and dust and dirt are easily trapped by the grease. Furthermore, after the cycling trip, the bicycles are positioned to the bicycle racks or in the car again, the mud on the tires is easily attached to the chains or the derailleur system to affect the operation of the bicycles.

Taiwan Utility Model No. 098220146 discloses a bicycle tire cover which is a flexible cover and has an outside and an inside. Two edges are formed along the cover and folded toward the inside of the tire cover, a space is defined between the two edges so as to accommodate the tire via an opening of the tire cover. The edges each have a resilient rope received therein and a portion of each of the resilient ropes protrudes from the cover. A fastening member is connected to the two protruded portions of the two resilient ropes. The tire is mounted by the cover and the two edges are folded downward, the resilient ropes are stretched and fastened by the fastening member to prevent the resilient ropes from bouncing back. Therefore, the tire is covered and the above mentioned shortcomings can be improved.

However, the tire has to be removed from the bicycle frame then the cover can be mounted to the tire. Obviously, this takes a lot of time and small parts such as nuts and quick releases can be lost.

The present invention intends to provide a bicycle tire cover which can be mounted to the bicycle tire without removing the tire from the bicycle frame.

### SUMMARY OF THE INVENTION

The present invention relates to a bicycle tire cover and comprises an elongate body with two edges. A first connection member is connected to the first end of the body and a second connection member is connected to the second end of the body. Two resilient portions are connected to the two edges respectively.

Preferably, the body is mounted to a tire, and the first and second connection portions are connected to each other. Each of the edges has a recess so as to allow a braking part of the bicycle to extend therethrough.

Preferably, multiple fixing portions are connected to the edges and each fixing portion has a first fixing member and a second fixing member. The first and second fixing members are connected to each other when the body is mounted to the tire.

Preferably, a handle is connected to an outside of the body.

Preferably, multiple openings are defined through the body so as to reduce resistance when the bicycle is located on top of the car.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the tire cover of the present invention;

FIG. 2 is a perspective view to show that the tire cover of the present invention is to be mounted to a tire;

FIG. 3 shows that the tire cover of the present invention is mounted to a tire;

FIG. 4 is a perspective view to show that the tire cover of the present invention is rolled to be compact size;

FIG. 5 shows the tire cover of the present invention with the first and second fixing members;

FIG. 6 shows the tire cover of the present invention with another embodiment of the first and second fixing members;

FIG. 7 shows that the two tire covers of the present invention are mounted to two tires of a bicycle which is secured on the top of a car;

FIG. 8 shows that the two ropes of the tire cover of the present invention are tied, and;

FIG. 9 shows that the two ropes of the tire cover of the present invention are cooperated with two fastening members.

### DETAILED DESCRIPTION OF THE PREFERRED EMBODIMENT

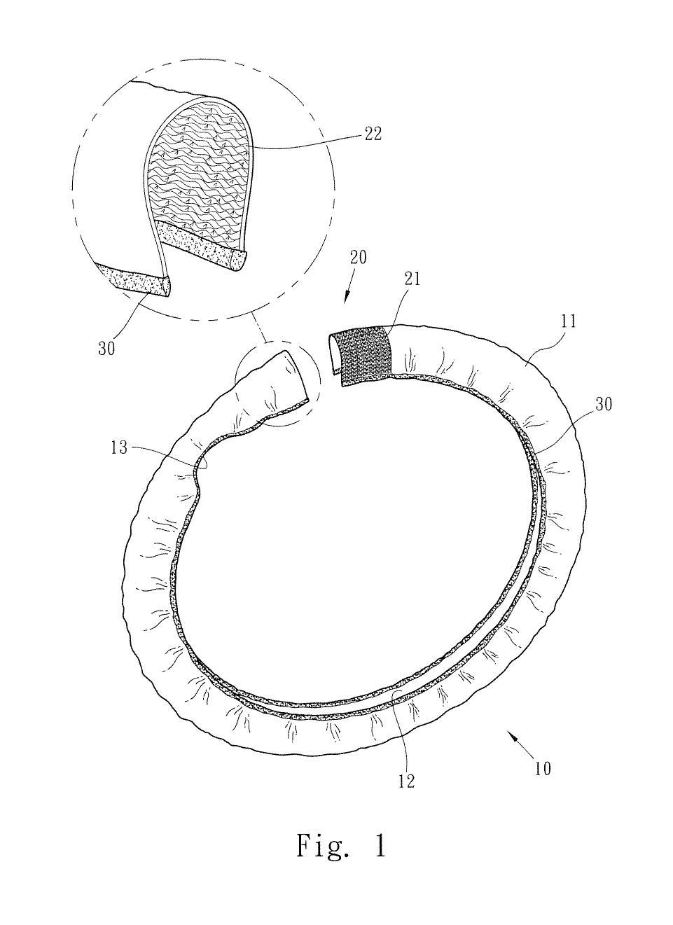

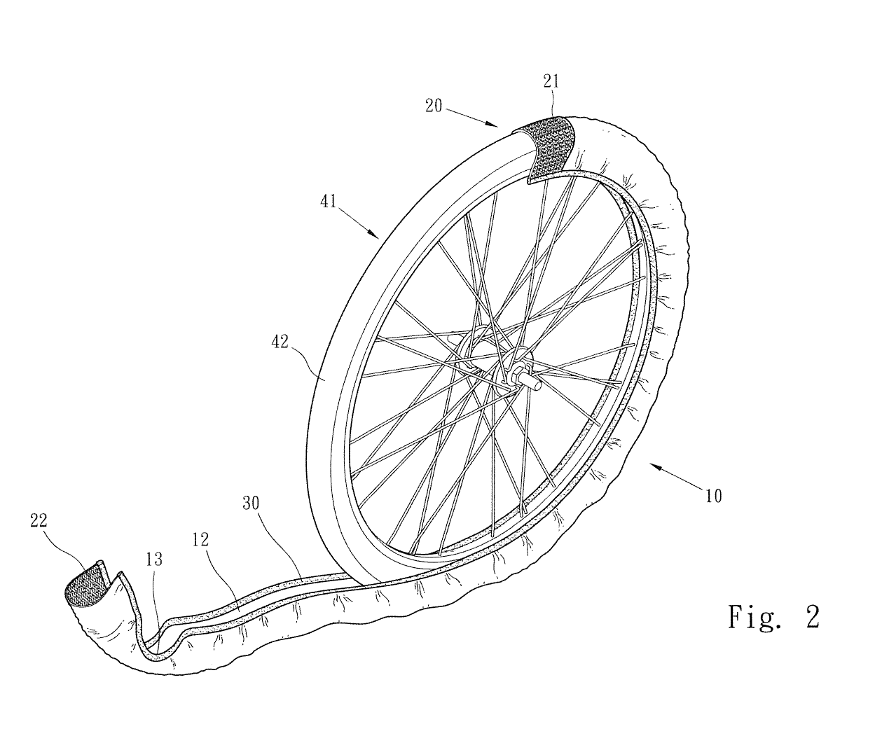

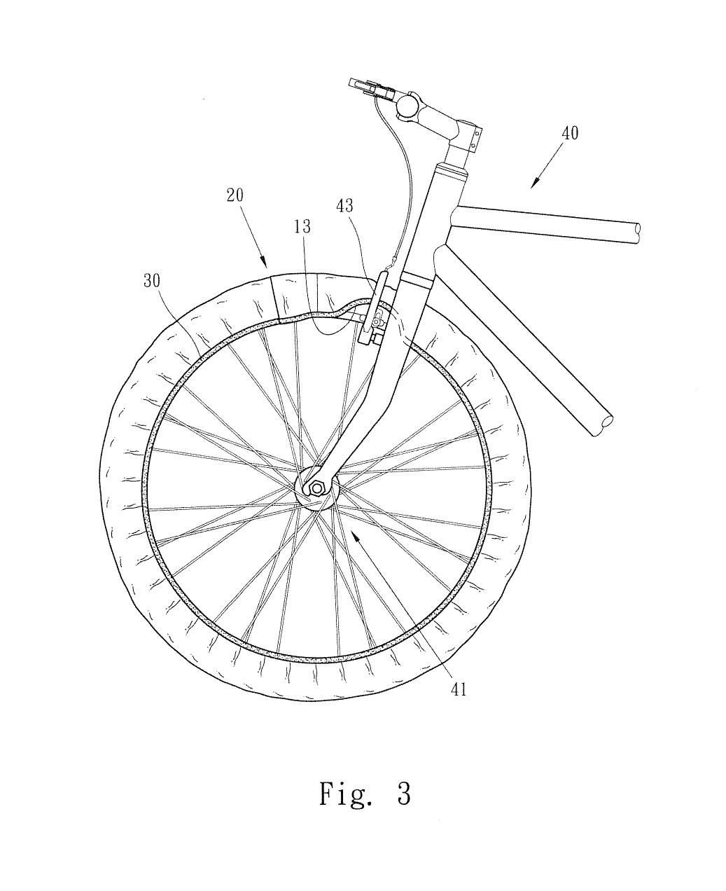

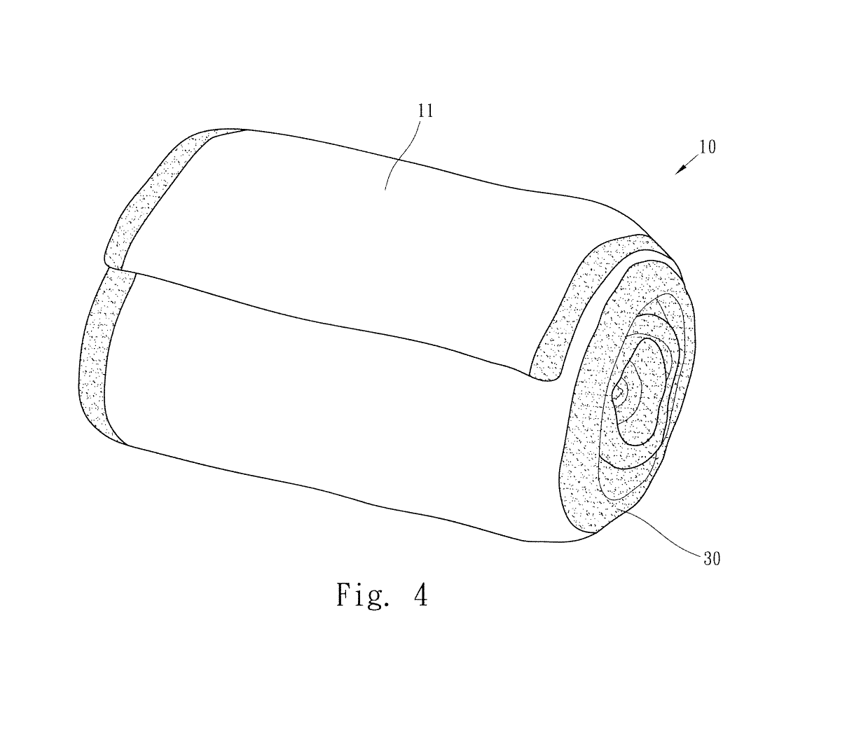

Referring to FIGS. 1 to 4, the bicycle tire cover 10 the present invention comprises an elongate body 11, a connection portion 20, two resilient portions 30 and multiple fixing portions 50.

The elongate body 11 has two edges which are folded downward to form the body as a U-shaped cover. A groove 12 is defined in the body 11 and located between the two edges so that the tire 42 is accommodated in the groove 12. Each of the edges has a recess 13.

The connection portion 20 has a first connection member 21 and a second connection member 22, wherein the first and second connection portions 21, 22 are connected to two ends of the body 11 respectively. The first and second connection portions 21, 22 can be connected to each other. In this embodiment, the first and second connection portions 21, 22 are hook-loop strips.

The two resilient portions 30 are connected to the two edges respectively. In this embodiment, the two resilient portions 30 are two resilient ropes 31 which are normally shrink so as to shrink the edges to let the body 11 to be shrunk status when not in use.

When in use, the body 11 is mounted to the tire 42 of the wheel unit 41 of the bicycle 40 so that the tire 42 is accommodated in the groove 12 and two ends of the body 11 are connected to each other to complete cover the tire 42. The recesses 13 of the edges allow the braking parts 43 of the bicycle 40 to extend therethrough.

The first and second connection portions 21, 22 on the two ends of the body 11 are connected to each other. The resilient portions 30 are expanded to easily pull the two edges to cover the two sides of the tire 42. Therefore, the tire 42 does not need to be removed from the bicycle 40 and the tire cover 10 is easily mounted to the tire 42.

When removing the tire cover 10 from the tire 42, the first and second connection portions 21, 22 are separated from each other, the resilient portions 30 shrink so that the edges can be easily removed from the tire 42 which is then removed from the groove 12. When the tire cover 10 is removed from the tire 42, the resilient portions 30 shrink and the tire cover 10 becomes compact and is easily to be stored.

The recesses 13 of the edges allow the braking parts 43 of the bicycle 40 to extend therethrough so that when mounting the tire cover 10 to the tire 42, the larger braking parts 43 do not interfere the tire cover 10 from mounting to the tire 42.

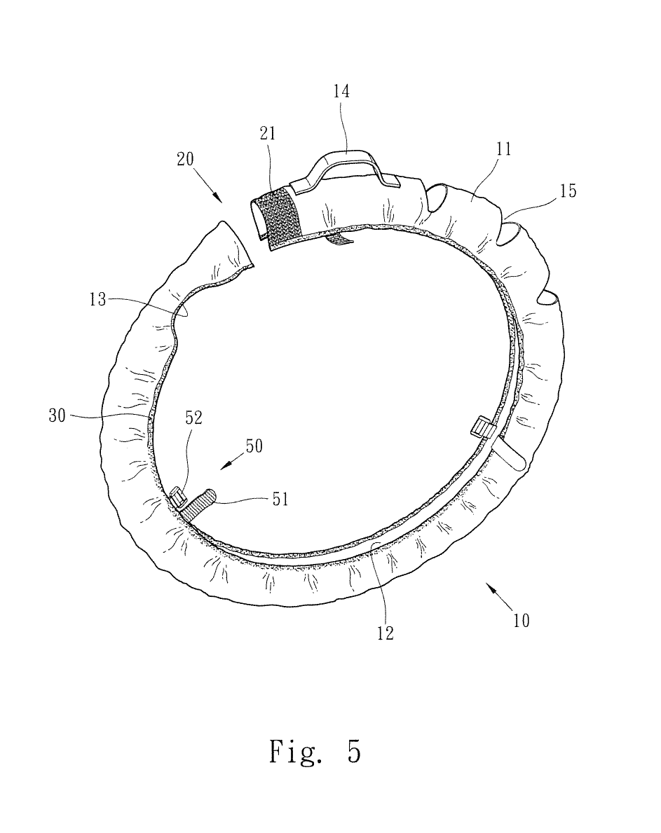

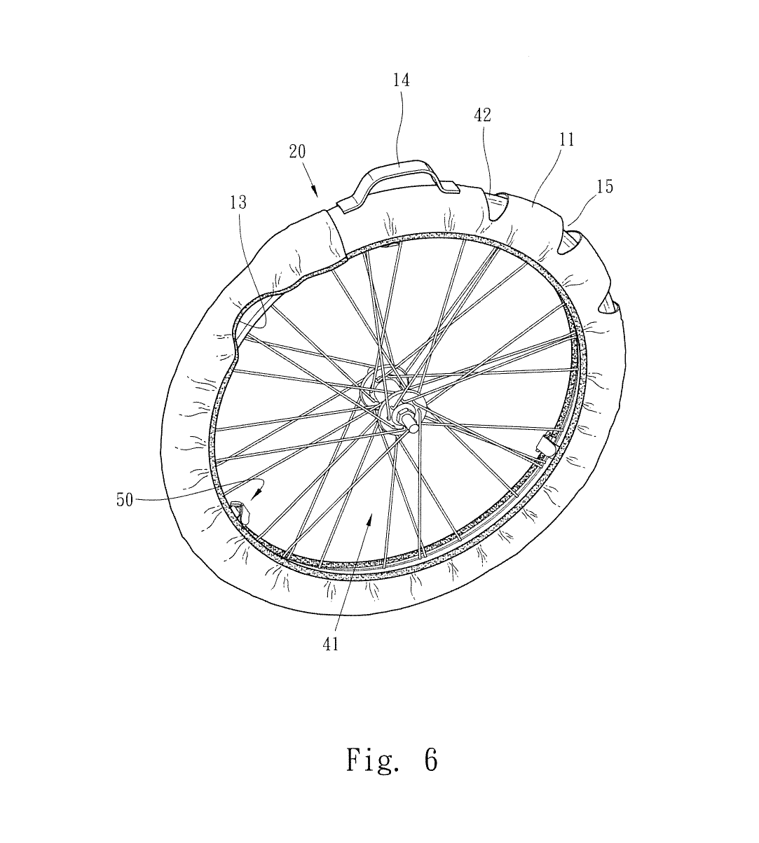

As shown in FIGS. 5 and 6, the multiple fixing portions 50 are connected to the edges and each fixing portion 50 has a first fixing member 51 and a second fixing member 52. The first fixing member 51 is a hook-loop strip and the second fixing member 52 is a ring, the first fixing member 51 extends across the rim of the wheel unit 41 and then turns backward to be fixed to the second fixing member 52. By this way, the two edges can be secured to the tire 42. Furthermore, a handle 14 is connected to the outside of the body 11 so that the user can carry the tire cover 10 when not in use.

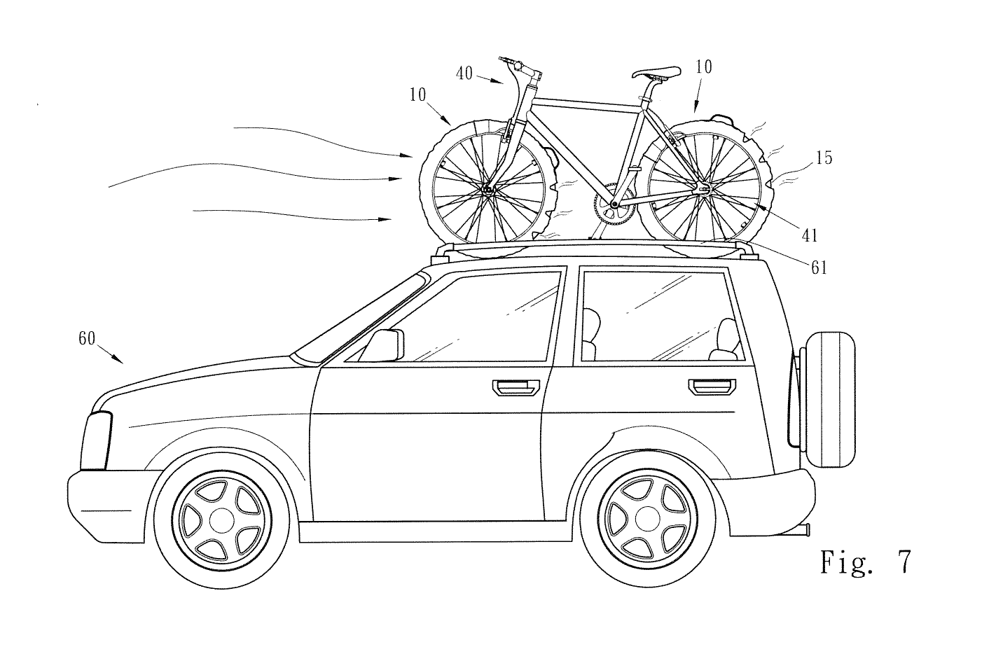

As shown in FIGS. 5 to 7, multiple openings 15 are defined through the body 11 so that when the bicycle is located on the top 61 of the car 60, the openings 15 allow air smoothly to pass therethrough to reduce resistance.

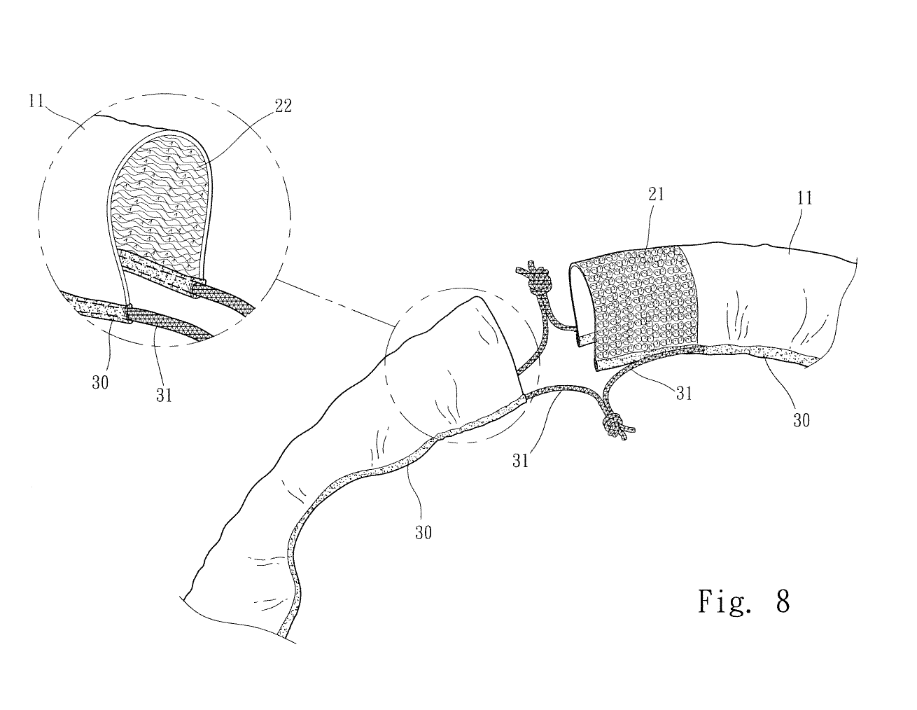

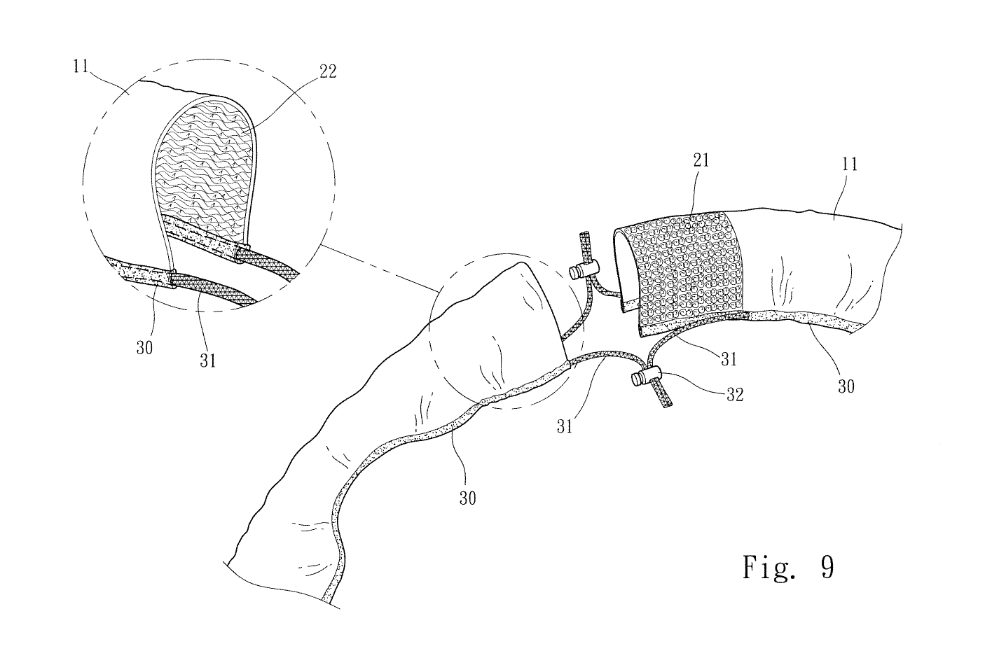

As shown in FIG. 8, the resilient portion 30 of each of two edges of the body 11 has a rope 31, when the first connection member 21 and the second connection member 22 are connected to each other, the two respective ropes 31 are pulled and tied to keep the resilient portions 30 in the stretched status and secure the tire cover 10. As shown in FIG. 9, a fastening member 32 is connected to two respective ends of each of the two ropes 31, when the first connection member 21 and the second connection member 22 are connected to each other, the two respective ends of each of the two ropes 31 are pulled so that the fastening members 32 secure the two ropes 31 and prevent the resilient portions 30 from bouncing back. The body 11 is made by water-proof material.

The tire cover 10 of the present invention is easily mounted to the tire 42 while the tire 42 does not need to be removed from the bicycle frame, this is convenient for the users when compared with the conventional tire cover. The recesses 13 allow the braking parts 43 to extend therethrough so that when mounting the tire cover 10 of the present invention, the time required is short. The tire cover 10 can be secured to the wheel unit 41 by the first and second connection members 21, 22, and the first and second fixing members 51, 52. When the tire cover 10 is not in use, it occupies limited space and easily carried and stored.

While we have shown and described the embodiment in accordance with the present invention, it should be clear to those skilled in the art that further embodiments may be made without departing from the scope of the present invention.

What is claimed is:

1. A bicycle tire cover comprising:
an elongate body having two edges;
a connection portion having a first connection member and a second connection member, the first and second connection portions connected to two ends of the body respectively, and
two resilient portions connected to the two edges respectively, the body adapted to be mounted to a tire, the first and second connection portions connected to each other.

2. The cover as claimed in claim 1, wherein each of the edges has a recess which is adapted to allow a braking part of a bicycle extending therethrough.

3. The cover as claimed in claim 1, wherein multiple fixing portions are connected to the edges and each fixing portion has a first fixing member and a second fixing member, the first and second fixing members are connected to each other when the body is adapted to mount to the tire.

4. The cover as claimed in claim 1, wherein a handle is connected to an outside of the body.

5. The cover as claimed in claim 1, wherein multiple openings are defined through the body.

6. The cover as claimed in claim 1, wherein the body is made by water-proof material.

7. The cover as claimed in claim 1, wherein the resilient portion of each of two edges of the body has a rope, when the first connection member and the second connection member are connected to each other, the two respective ropes are pulled and tied.

8. The cover as claimed in claim 1, wherein the resilient portion of each of two edges of the body has a rope, a fastening member is connected to two respective ends of the two ropes, when the first connection member and the second connection member are connected to each other, the two respective ends of the two ropes are pulled and the fastening member secures the two respective ends of the two ropes.
